(19) United States
(12) Patent Application Publication
(10) Pub. No.: US 2012/0289650 A1
(43) Pub. Date: Nov. 15, 2012

(54) PROCESSES FOR THE PREPARATION OF AQUEOUS DISPERSIONS BASED ON POLYURETHANEUREAS

(75) Inventors: Rolf Gertzmann, Leverkusen (DE); Henricus Peerlings, Solingen (DE)

(73) Assignee: Bayer Intellectual Propert GmbH, Monheim (DE)

(21) Appl. No.: 13/574,441

(22) PCT Filed: Jan. 19, 2011
(86) PCT No.: PCT/EP2011/050684

§ 371 Date: Jul. 20, 2012

(30) Foreign Application Priority Data
Jan. 21, 2010 (EP) 1000563.6

(51) Int. Cl. C08L 75/12; C09D 175/12

(52) U.S. Cl. 524/591

(57) ABSTRACT

The present invention relates to processes for the preparation of aqueous dispersions based on polyurethaneureas and to the use of these dispersions in coating agents.

The present invention relates to processes for the preparation of aqueous dispersions based on polyurethaneureas and to the use of these dispersions in coating agents.

DE-A 19653585 describes polyurea dispersions which, after physical drying at 20 to 100° C., give transparent, high-gloss lacquers resistant to UV, temperature (−30 to 80° C.) and deposits (of an organic or inorganic nature) which on the one hand adhere well and on the other hand can easily be peeled off. The tear strength and stretch of the lacquer layers are reasonably high, as described e.g. in DE-A 19653585. However, the film-forming properties of the products are inadequate and in some cases have to be adjusted by the addition of solvents.

DE-A 10311420 describes polyether-based peelable lacquers, but these do not have the required light stability.

EP-B 1072652 and EP-A 1132413 describe costly processes for the preparation of polyurethane dispersions wherein two polyurethane dispersions of different glass transition temperature are mixed or acrylate monomers are additionally grafted on to the polyurethane dispersion.

Patent applications EP-A 1338634 and DE-A 10311420 mention the use of monoamines, but omit to describe either the process for incorporating this component into the dispersion, or the resulting effect. The coatings are incapable of optimal film formation without a solvent below room temperature.

The users of such lacquers now wish to have coating agents which, after their use in lacquers, exhibit improved water resistance and peelability in addition to the conventional advantageous properties such as light stability and acid resistance.

One object of the present invention was therefore to provide processes for the preparation of novel aqueous anionic polyurethane dispersions which, when used, give lacquers and coatings that exhibit improved peelability and water resistance.

Another object of the present invention was therefore to provide processes for the preparation of novel aqueous anionic polyurethane dispersions which, when used, give lacquers and coatings that exhibit improved peelability and water resistance without detracting from other advantageous properties such as high lightfastness, high transparency, high temperature resistance and high resistance to deposits (of an organic and inorganic nature).

It has now been found, surprisingly, that the desired technical application properties are obtained when diamines and monofunctional amines are added successively in the preparation of the polyurethane dispersions.

Suitable dispersions for lightfast coating agents are based on cosolvent-poor or cosolvent-free, aqueous anionic dispersions of polyurethanepolyureas whose solids contain the reaction product at least partially in salt form, and which comprise
a) at least one NCO prepolymer comprising
i) 20 to 60 wt. % of at least one diisocyanate,
ii) 20 to 80 wt. % of at least one macrodiol with a number-average molecular weight of 500 to 10,000,
iii) 2 to 12 wt. % of at least one 2,2-bis(hydroxymethyl)alkanemonocarboxylic acid,
iv) 0 to 15 wt. % of at least one short-chain diol with a number-average molecular weight of 62 to 499, and
v) 0 to 10 wt. % of at least one monohydric alcohol with a number-average molecular weight of 32 to 3500;
b) 0.1 to 15 wt. % of at least one diamine with a number-average molecular weight of 60 to 300;
c) 0.1 to 5 wt. % of at least one monofunctional amine; and
d) 0.1 to 10 wt. % of at least one neutralizer,
   the amounts of components a), b), c) and d) adding up to 100%, characterized in that the total amount of component c) is added before the total amount of component b).

The addition of the total amount of component c) and the addition of the total amount of component b) are separated by an interval preferably of 0 to 10 hours, particularly preferably of 0 to 3 hours and very particularly preferably of 0 to 1 hour.

In the prepolymer stage a) the NCO content is adjusted preferably to 65 to 85%, particularly preferably to 70% to 80%, of the calculated value.

The acid number of the prepolymer is preferably in the range from 5 to 35 mg KOH/g, particularly preferably in the range from 8 to 25 mg KOH/g.

The polyurethane dispersions prepared according to the invention are cosolvent-poor. They contain preferably 0.0 to 0.9 wt. %, particularly preferably 0.0 to 0.5 wt. % and very particularly preferably 0.0 to 0.4 wt. % of cosolvents, based on the total amount of polyurethane dispersion.

The coating agents prepared according to the invention are cosolvent-poor. They contain preferably 0.0 to 0.9 wt. %, particularly preferably 0.0 to 0.5 wt. % and very particularly preferably 0.0 to 0.4 wt. % of cosolvents, based on the total amount of coating agent.

In terms of the present invention, cosolvents are polar organic solvents, preferably organic solvents with a Hansen parameter ranging from 7.2 to 16.0 (cal/cm³)^{0.5}, such as those published in “Polymers Handbooks”, ed. Brandrup, J.; Immergut, E. H.; Grulke, E. A., 4th Edition, John Wiley, New York, 1999, VII/pages 675-711.

In terms of the present invention, preferred cosolvents are polar organic solvents selected from the group comprising acetone, methyl ethyl ketone, butyl diglycol, dimethyl sulfoxide, N-ethylpyrrolidone, dimethylformamide, dimethylacetamide, N-methylpyrrolidone, butylene glycol and dipropylene glycol dimethyl ether.

The diisocyanates preferably used as component a)i) are aliphatic and/or cycloaliphatic diisocyanates, e.g. diisocyanates selected from the group comprising isophorone diisocyanate (IPDI), 4,4 ′-dicyclohexylmethane diisocyanate, 1-methyl-2,4-diisocyanatocyclohexane, 1-methyl-2,6-diisocyanatocyclohexane, 1,6-hexamethylene diisocyanate and 1,3-cyclohexane diisocyanate. Component a)i) is used preferably in an amount of 20 to 60 wt. %, particularly preferably in an amount of 20 to 50 wt. %, based on the sum of all the components a), b), c) and d).

The concomitant use of small proportions of aromatic diisocyanates, e.g. 2,4- and 2,6-toluene diisocyanate or 2,4′- and 4,4′-diphenylmethane diisocyanate, is also possible. The aromatic diisocyanates are preferably used in an amount of 0 to 10 wt. %, based on the total amount of component a)i).

The macrodiols used as component a)ii) are those with a molecular weight of 500 to 10,000. They are preferably polyesterdiols obtained by reacting dicarboxylic acids or their anhydrides with diols, optionally with the aid of conventional esterification catalysts, preferably according to the principle of a melt or azeotropic condensation, at temperatures of 140-240° C. Component a)ii) is used preferably in an amount of 20 to 80 wt. %, particularly preferably in an amount of 30 to 70 wt. %, based on the sum of all the components a), b), c) and d).

Examples of suitable dicarboxylic acids or their anhydrides are adipic acid, succinic acid (anhydride), maleic acid (anhydride), sebacic acid, azelaic acids, dimeric fatty acids (in hydrogenated and non-hydrogenated form), phthalic acid (anhydride), isophthalic acid, tetrahydrophthalic acid (anhydride), 1,4-cyclohexanedicarboxylic acid and hexahydrophthalic acid (anhydride). The diols used are the industrially available diols, e.g. ethylene glycol, 1,2- and 1,3-propanediol, 1,3- and 1,4-butanediol, 1,6-hexanediol, diethylene glycol, dipropylene glycol, neopentyl glycol or mixtures of such diols. Preferred polyesterdiols as component a)ii) are those of adipic acid, hexanediol and neopentyl glycol.

Other compounds suitable as component a)ii) are polycarbonatediols, polycaprolactonediols, hydroxypolytetrahydrofurans or hydroxypolyethers based on propylene oxide.

Suitable polycarbonatediols are obtained e.g. by reacting carbonic acid derivatives, such as diphenyl carbonate or phosgene, with alcohols, preferably diols of said type.

The average molecular weight of the polyols of component a)ii) is between 500 and 10,000, preferably between 700 and 4000; particularly preferred macrodiols are those with molecular weights between 1000 and 2500 g/mol.

Starting components a)iii) are preferably 2,2-bis(hydroxymethyl)alkanemonocarboxylic acids having a total of 5-8 carbon atoms, i.e. compounds of general formula (I):

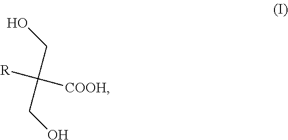

in which
R is an alkyl radical having 1-4 carbon atoms.
R is preferably an unsubstituted alkyl radical having 1-4 carbon atoms.
Very particularly preferably, component a)iii) is 2,2-dimethylolpropionic acid.

Component a)iii) is used preferably in an amount of 2 to 12 wt. %, particularly preferably in an amount of 2 to 8 wt. %, based on the sum of all the components a), b), c) and d).

Possible starting components a)iv) are short-chain diols with a molecular weight in the range 62-499. Particularly preferred as component a)iv) are compounds selected from the group comprising 1,4-butanediol, 1,4-cyclohexanedimethanol and 1,6-hexanediol. Component a)iv) is used preferably in an amount of 0 to 15 wt. %, particularly preferably in an amount of 0 to 10 wt. %, based on the sum of all the components a), b), c) and d).

Possible starting components a)v) are alcohols with a molecular weight in the range from 32 to 3500. It is preferable to use alcohols selected from the group comprising methanol, ethanol, butanol, hexanol, 2-ethylhexanol, octanol and dodecanol. It is also preferable to use monofunctional polyethylene glycol. Component a)v) is used preferably in an amount of 0 to 15 wt. %, particularly preferably in an amount of 0 to 10 wt. %, based on the sum of all the components a), b), c) and d).

As component b) it is possible to use any aliphatic and/or cycloaliphatic compounds that carry at least two isocyanate-reactive amino groups and have a molecular weight in the range from 60 to 300. Particularly preferably, component b) is selected from the group comprising ethylenediamine, propylenediamine, butylenediamine, hexamethylenediamine, isophoronediamine, piperazine, p-xylylenediamine, 4,4′-diaminodicyclohexylmethane and 4,4′-diamino-3,3′-dimethyldicyclohexylmethane. Very particularly preferably, component b) is selected from the group comprising ethylenediamine, isophoronediamine and 4,4′-diaminodicyclohexylmethane. Component b) is used preferably in an amount of 0.1 to 15 wt. %, particularly preferably in an amount of 0.5 to 10 wt. % and very particularly preferably in an amount of 0.5 to 5 wt. %, based on the sum of all the components a), b), c) and d).

Possible components c) are monofunctional amines such as primary amines selected from the group comprising methylamine, ethylamine, n-propylamine, n-butylamine, n-octylamine, laurylamine, stearylamine, isopropylamine and cyclohexylamine, and secondary amines selected from the group comprising dimethylamine, diethylamine, diisopropylamine, dibutylamine and piperidine. It is particularly preferable to use secondary amines like dibutylamine. Of course, mixtures of these can also be used. Component c) is used preferably in an amount of 0.1 to 5 wt. %, particularly preferably in an amount of 0.2 to 3 wt. %, based on the sum of all the components a), b), c) and d).

Examples of suitable neutralizers d) are ammonia, N-methylmorpholine, dimethylisopropanolamine, triethylamine, dimethylethanolamine, methyldiethanolamine, triethanolamine, morpholine, tripropylamine, ethanolamine, diethanolamine, triiso-propanolamine, N-ethyldiisopropylamine and mixtures thereof Component d) is preferably used in an amount of 0.1 to 10 wt. %, based on the sum of all the components a), b), c) and d).

In one preferred embodiment, components a)i), ii) and iii) are placed in a reactor and reacted under anhydrous conditions in a temperature range of 50-150° C., preferably of 50-110° C., for a period of 5 min to 10 h, preferably for a period of 30 min to 2 h, after which the batch is cooled, technical-grade acetone and optionally the short-chain diol (iv) are added and the mixture is heated until its NCO content has fallen to a value of 65 to 85% of the calculated value. The NCO prepolymer is formed in this way. The batch is then diluted with more acetone, and the calculated amounts of components b) and c) are added in succession, the first component added being dissolved in water. The mixture is then stirred for a period of 10 min to 10 h, preferably of 30 min to 2 h, at a temperature in the range from 30° C. to 80° C., preferably in the range from 40° C. to 80° C. This is followed by reaction with component e), dispersion in water and removal of the acetone under reduced pressure.

The polymer synthesis reaction, i.e. the preparation of the prepolymer a), is preferably carried out without the use of catalysts, but it is also possible to use the catalysts known in isocyanate chemistry (e.g. tertiary amines such as triethylamine, tin compounds such as tin(II) octanoate and dibutyltin dilaurate, and other conventional catalysts).

When NCO is no longer detectable, e.g. after appropriate monitoring by IR, the calculated amount of neutralizer, preferably ammonia solution, is added to the batch so that 50-100% of the carboxyl groups present are neutralized by the neutralizer or ammonia.

The solids concentration is adjusted to the desired value by adding water and then distilling off the acetone used. The solids content of the polyurethanepolyurea dispersions obtained by the process according to the invention is preferably in the range 20-60 wt. %, particularly preferably in the range 30-40 wt. %, in water.

The polyurethane dispersion prepared according to the invention has particles with a mean diameter preferably in the range 20-1000 nm, particularly preferably in the range 50-500 nm, as measured by the dynamic light scattering method according to ISO 13320-1.

The pH values of the white, storage-stable polyurethanepolyurea dispersions prepared according to the invention are in the range 6-9.

The dispersion prepared according to the invention can be blended with other anionic or non-ionic dispersions, e.g. plastics dispersions of polyvinyl acetate, polyethylene, polystyrene, polybutadiene, polyvinyl chloride, polyacrylate and copolymers.

Any desired adaptation of the pH of the mixtures can be effected with organic or inorganic bases, e.g. ammonia, alkali metal carbonates, amines or aminoalcohols, organic bases being preferred. 2-Amino-2-methyl-1-propanol is very particularly preferred.

The invention also provides the use of the polyurethanepolyureas prepared according to the invention in coating agents for producing high-gloss, lightfast, weather-resistant, solventless lacquers and coatings. These lacquers and coatings are used for protecting motor vehicles, steel, aluminium and metal objects of all kinds, glass and plastic objects of all kinds, mineral substrates, and brickwork or natural stones, for protecting ships, bridges, aircraft and railway lines from corrosion, and for protecting objects made of wood and natural substances, and any other substrates. The coating agents are applied by dipping, doctor blade coating, pouring, atomizing, brushing or spraying and then dried at 120 to 150° C.

The invention also provides the use of the polyurethanepolyureas prepared according to the invention in coating agents for producing recyclable peelable lacquers. These peelable lacquers are used for the temporary protection of motor vehicles, railway lines, ships, furniture, metal objects, mineral objects, glass and plastic objects and any other substrates. The coating agents are applied for these purposes by dipping, doctor blade coating, pouring, atomizing, spraying or brushing and then dried at 20 to 100° C., preferably at 20 to 80° C., by heat or infrared light, microwave radiation or sonication.

The coatings according to the invention are transparent, optionally pigmented coatings resistant to water, tearing, UV, temperature and deposits (of an organic or inorganic nature) which on the one hand adhere to the substrates and on the other hand can easily be peeled off

The formulation of the lacquers can include the auxiliary substances conventionally used in lacquer chemistry, e.g. pigments, light stabilizers, antisettling agents, thickeners, surface-active compounds, defoamers, etc.

The lacquers are applied by the conventional methods of lacquer technology, i.e. by dipping, doctor blade coating, pouring, atomizing, spraying, brushing or rolling. They are used as peelable lacquers for the temporary protection of motor vehicles, steel and aluminium profiles, and glass and plastic sheets or articles. After application, the lacquered parts are dried at room temperature or at an elevated temperature of up to 100° C.

The polyurethaneurea dispersions prepared according to the invention are dried for up to 30 minutes at 140-150° C. to form coatings that adhere well to the substrates. Drying temperatures above 150° C. are of course also possible, but the use of such high temperatures is generally uneconomic.

### EXAMPLES

### Example 1

170 g (0.1 mol) of a polyester of adipic acid, 1,6-hexanediol and neopentyl glycol, with an average molecular weight of 1700 g/mol and an OH content of 2%, are dehydrated in a reaction vessel for 30 minutes at 120° C. and 10 mbar, with stirring. 13.4 g (0.1 mol) of dimethylolpropionic acid and 111 g (0.5 mol) of isophorone diisocyanate are introduced under nitrogen. After a reaction time of 1 hour at 110° C., the batch is cooled to 60° C. and dissolved in 100 g of acetone. 18 g (0.2 mol) of 1,4-butanediol are added and stirring is then continued for 22 hours at 50° C. The NCO content is 1.60% (calculated: 2.04%). After dilution with 500 g of acetone, a mixture of 10.6 g (0.062 mol) of isophoronediamine, 1.07 g (0.016 mol) of 25% ammonia solution and 60 g of water is added to the NCO prepolymer at 50° C. Stirring is then continued for 5 hours at 50° C. The batch is neutralized with 3.4 g (0.05 mol) of 25% ammonia solution and dispersed with 450 g of water. The acetone is removed up to 50° C. and 150 mbar to give a white dispersion with a solids content of 39.2% and a mean particle size of 263 nm

The degree of neutralization is 50%.

### Example 2

170 g (0.1 mol) of a polyester of adipic acid, 1,6-hexanediol and neopentyl glycol, with an average molecular weight of 1700 g/mol and an OH content of 2%, are dehydrated in a reaction vessel for 30 minutes at 120° C. and 10 mbar, with stirring. 13.4 g (0.1 mol) of dimethylolpropionic acid and 111 g (0.5 mol) of isophorone diisocyanate are introduced under nitrogen. After a reaction time of 1 hour at 110° C., the batch is cooled to 60° C. and dissolved in 100 g of acetone. 18 g (0.2 mol) of 1,4-butanediol are added and stirring is then continued for 22 hours at 50° C. The NCO content is 1.60% (calculated: 2.04%). After dilution with 500 g of acetone, firstly 10.6 g (0.062 mol) of isophoronediamine in 60 g of water and then 2.1 g (0.016 mol) of dibutylamine are added to the NCO prepolymer at 50° C. Stirring is then continued for 5 hours at 50° C. The batch is neutralized with 7.2 g (0.063 mol) of 15% ammonia solution and dispersed with 450 g of water. The acetone is removed up to 50° C. and 150 mbar to give a white dispersion with a solids content of 39% and a mean particle size of 185 nm.

The degree of neutralization is 63%.

### Example 3

170 g (0.1 mol) of a polyester of adipic acid, 1,6-hexanediol and neopentyl glycol, with an average molecular weight of 1700 g/mol and an OH content of 2%, are dehydrated in a reaction vessel for 30 minutes at 120° C. and 10 mbar, with stirring. 10.5 g (0.078 mol) of dimethylolpropionic acid and 111 g (0.5 mol) of isophorone diisocyanate are introduced under nitrogen. After a reaction time of 1 hour at 110° C., the batch is cooled to 60° C. and dissolved in 100 g of acetone. 19.8 g (0.22 mol) of 1,4-butanediol are added and stirring is then continued for 22 hours at 50° C. The NCO content is 1.60% (calculated: 2.06%). After dilution with 600 g of acetone, firstly 9.5 g (0.056 mol) of isophoronediamine in 60 g of water and then 2.22 g (0.017 mol) of dibutylamine are added to the NCO prepolymer at 50° C. Stirring is then continued for 5 hours at 50° C. The batch is neutralized with 7.2 g (0.063 mol) of 15% ammonia solution and dispersed with 463 g of water. The acetone is removed up to 50° C. and 150 mbar to give a white dispersion with a solids content of 38% and a mean particle size of 218 nm The degree of neutralization is 81%.

### Example 4

170 g (0.1 mol) of a polyester of adipic acid, 1,6-hexanediol and neopentyl glycol, with an average molecular weight of 1700 g/mol and an OH content of 2%, are dehydrated in a reaction vessel for 30 minutes at 120° C. and 10 mbar, with stirring. 10.5 g (0.078 mol) of dimethylolpropionic acid and 111 g (0.5 mol) of isophorone diisocyanate are introduced under nitrogen. After a reaction time of 1 hour at 110° C., the batch is cooled to 60° C. and dissolved in 100 g of acetone. 19.8 g (0.22 mol) of 1,4-butanediol are added and stirring is then continued for 22 hours at 50° C. The NCO content is 1.60% (calculated: 2.06%). After dilution with 600 g of acetone, a mixture of 2.22 g (0.017 mol) of dibutylamine and 9.5 g (0.056 mol) of isophoronediamine, and finally 60 g of water, are added to the NCO prepolymer at 50° C. Stirring is then continued for 5 hours at 50° C. The batch is neutralized with 7.2 g (0.063 mol) of 15% ammonia solution and dispersed with 463 g of water. The acetone is removed up to 50° C. and 150 mbar to give a white dispersion that is not stable on storage. The particle size is >3000 nm The degree of neutralization is 81%.

### Testing of the Water Resistance of the Film

Using a chamber doctor blade (150 μm) a film was drawn from both dispersions without the aid of a cosolvent, and stored in a water bath for 24 hours. A qualitative assessment was then made of the peelability and haze of the film.

| | Example 1 | Example 2 | Example 3 | Example 4 |
|---|---|---|---|---|
| Type of | Comparative | According to | According to | Comparative |
| Example | | the invention | the invention | |
| Peelability | Good, but | Good, cannot | Good, cannot | Cannot be |
| | can easily be | be rubbed off | be rubbed off | applied |
| | rubbed off | | | |
| Haze | Hazy | Transparent | Transparent | Unstable |

Comparative Example 1 describes a polyurethane dispersion which can easily be peeled off, but the film detaches too easily from the substrate; this is undesirable, e.g. if the vehicle is transported in the rain and the film is removed from the vehicle by the airstream.

By contrast, Examples 2 and 3 according to the invention describe a film which can easily be peeled off and which, as desired, cannot be rubbed off the substrate, even after water treatment.

Comparative Example 4 describes a polyurethane dispersion which cannot be applied.

1-8. (canceled)

9. A process for preparing aqueous dispersions comprising polyurethaneureas which comprise
a) at least one NCO prepolymer comprising
i) 20 to 60 wt. % of at least one diisocyanate,
ii) 20 to 80 wt. % of at least one macrodiol with a number-average molecular weight of 500 to 10,000,
iii) 2 to 12 wt. % of at least one 2,2-bis(hydroxymethyl)alkanemonocarboxylic acid,
iv) 0 to 15 wt. % of at least one short-chain diol with a number-average molecular weight of 62 to 499, and
v) 0 to 10 wt. % of at least one monohydric alcohol with a number-average molecular weight of 32 to 3500;
b) 0.1 to 15 wt. % of at least one diamine with a number-average molecular weight of 60 to 300;
c) 0.1 to 5 wt. % of at least one monofunctional amine; and
d) 0.1 to 10 wt. % of at least one neutralizer,
the amounts of components a), b), c) and d) adding up to 100%, characterized in that the total amount of component c) is added before the total amount of component b).

10. The process of claim 9, wherein the addition of the total amount of component c) and the addition of the total amount of component b) are separated by an interval of from 0 to 10 hours.

11. The process of claim 9, wherein component c) is a secondary amine selected from the group consisting of dimethylamine, diethylamine, diisopropylamine, dibutylamine, and piperidine.

12. The process of claim 9, wherein component b) is selected from the group consisting of ethylenediamine, propylenediamine, butylenediamine, hexamethylenediamine, isophoronediamine, piperazine, p-xylylenediamine, 4,4′-diaminodicyclohexylmethane, and 4,4′-diamino-3,3′-dimethyldicyclohexylmethane.

13. An aqueous dispersion prepared by the process of claim 9.

14. A coating agent comprising the aqueous dispersion of claim 13.

15. A lacquer or coating prepared from the coating agent of claim 14.
